(19) United States
(12) Patent Application Publication
(10) Pub. No.: US 2024/0375530 A1
(43) Pub. Date: Nov. 14, 2024

(54) Scalable Adapter for a Vehicle Charging Process

(71) Applicant: Bayerische Motoren Werke Aktiengesellschaft, Muenchen (DE)

(72) Inventors: Zack CUI, Changchun (CN); Boris ZUEV, Muenchen (DE)

(21) Appl. No.: 18/684,611

(22) PCT Filed: Aug. 11, 2022
(86) PCT No.: PCT/EP2022/072619

§ 371 Date: Feb. 16, 2024

(30) Foreign Application Priority Data
Aug. 17, 2021 (DE) 10 2021 121 377.0

(51) Int. Cl. B60L 53/16; B60L 53/18; H02J 7/00

(52) U.S. Cl. CPC B60L 53/16; B60L 53/18; H02J 7/0042

(57) ABSTRACT

An adapter for a charging process of a vehicle having a vehicle-side charging interface, which is designed in accordance with a vehicle-side charging standard, at a charging station having a charging-station-side charging interface, which is designed in accordance with a charging-station-side charging standard, is disclosed. The adapter includes a base adapter, which has a vehicle-side adapter interface for connecting to the vehicle-side charging interface and a charging-station-side adapter interface for connecting to the charging-station-side charging interface. The base adapter is designed to be operated with a base charging current when no temperature monitoring is performed. The base adapter is designed to be expanded, for temperature monitoring of the base adapter, with an expansion module, so that the base adapter can be operated with an increased charging current in comparison with the base charging current while temperature monitoring is performed.

### BACKGROUND AND SUMMARY

The invention relates to a charging adapter for charging a vehicle.

A vehicle with an electric drive (in particular a battery-operated electric vehicle or a plug-in hybrid vehicle) comprises an electrical energy storage device (in particular an electrochemical battery) which can be connected to a charging station external to the vehicle via a charging device of the vehicle and can be charged. Various conductive, that is to say wired, charging technologies exist for charging the electrical energy storage device. In the case of what is known as AC charging or alternating-current charging, the charging device, which converts the direct current (also referred to as DC current) for charging the electrical energy storage device, is located in the vehicle. An AC current or alternating current is transmitted on the charging cable between the charging station and the vehicle. In the case of what is known as DC charging or direct-current charging, a DC current or direct current is transmitted on the charging cable.

Different charging stations and/or different vehicles may possibly have different specifications for carrying out charging processes. For example, in China, the GB/T charging standard or the ChaoJi standard can be used. The different charging standards may differ in relation to the plug system used in each case and/or in relation to the data communication during a charging process.

The present document deals with the technical object of efficiently and reliably making possible charging processes in which the charging station and the vehicle have different charging standards.

The object is achieved by the independent claim. Advantageous embodiments are described, inter alia, in the dependent claims. It is pointed out that additional features of a patent claim dependent on an independent patent claim can form, without the features of the independent patent claim or only in combination with a subset of the features of the independent patent claim, a separate invention which is independent of the combination of all features of the independent patent claim and can be made into the subject matter of an independent claim, a divisional application or a subsequent application. This applies in the same manner to technical teachings which are described in the description and can form an invention independent of the features of the independent patent claims.

One aspect describes an adapter for a (DC) charging process of a (motor) vehicle (in particular a truck, a passenger vehicle, a bus, a motorbike, etc.) having a vehicle-side charging interface, which is designed in accordance with a vehicle-side charging standard, at a charging station having a charging-station-side charging interface, which is designed in accordance with a charging-station-side charging standard. In this case, the charging-station-side charging standard may differ from the vehicle-side charging standard. In particular, an arrangement of contact elements of the two charging standards may differ from one another. As an alternative or in addition, a communication protocol of the two charging standards may differ from one another. The charging-station-side charging standard may be the GB/T charging standard. The vehicle-side charging standard may be the ChaoJi charging standard.

The adapter comprises a base adapter having a vehicle-side adapter interface (for example a plug) for connecting to the vehicle-side charging interface (for example a socket) and having a charging-station-side adapter interface (for example a socket) for connecting to the charging-station-side charging interface (for example a plug). The vehicle-side adapter interface may be designed so as to be complementary to the vehicle-side charging interface, in particular in such a way that the two interfaces form a plug system. Furthermore, the vehicle-side adapter interface may be designed in accordance with the vehicle-side charging standard. Correspondingly, the charging-station-side adapter interface may be designed so as to be complementary to the charging-station-side charging interface, in particular in such a way that the two interfaces form a plug system. Furthermore, the charging-station-side adapter interface may be designed in accordance with the charging-station-side charging standard.

The vehicle-side adapter interface may comprise one or more (in particular two) power contact elements (for transmitting the charging current) and one or more communication contact elements (for transmitting communication signals), which are configured (in particular arranged) in accordance with the vehicle-side charging standard. Correspondingly, the charging-station-side adapter interface may comprise one or more (in particular two) power contact elements (for transmitting the charging current) and one or more communication contact elements (for transmitting communication signals), which are configured (in particular arranged) in accordance with the charging-station-side charging standard.

The base adapter may comprise one or more power lines between the one or more power contact elements of the vehicle-side adapter interface and the one or more power contact elements of the charging-station-side adapter interface. Moreover, the base adapter may comprise one or more communication lines between the one or more communication contact elements of the vehicle-side adapter interface and the one or more communication contact elements of the charging-station-side adapter interface. The one or more communication contact elements and/or the one or more communication lines may be part of a data bus, in particular a CAN bus.

The base adapter is designed or configured to be operated with a (specific, maximum possible) base charging current (for example with a base charging current of up to 125 A) when no temperature monitoring is performed.

The base adapter is also designed to be expanded and/or connected, for monitoring the temperature of the base adapter, with an expansion module. The expansion module may be designed, for example, to be arranged on a housing wall of the housing of the base adapter. The base adapter may be designed to be operated with an increased (maximum possible) charging current in comparison with the base charging current when temperature monitoring is performed. The base adapter may be designed, in particular, in such a way that, through the temperature monitoring process, the increased charging current is at least doubled in comparison with the base charging current.

A description is therefore given of a scalable adapter for charging processes which, when needed, may be expanded, for monitoring the temperature of the base adapter, with an expansion module in order to efficiently increase the permissible and/or possible charging current of the (base) adapter. It is thus possible to provide a cost-efficient (passive, without an energy supply) base adapter for a base charging current which can be expanded by an (active, with an energy supply) expansion module.

The base adapter may comprise a temperature sensor which is set up to capture temperature data in relation to the temperature of the base adapter, in particular in relation to the temperature of an electrical power line of the base adapter. The temperature sensor may be arranged in the immediate vicinity of the power line for this purpose.

The base adapter may also comprise (for example on the housing wall facing the expansion module) an interface for providing the temperature data to the expansion module and/or for taking up electrical energy from the expansion module for the operation of the temperature sensor. An electrical line of the base adapter may be arranged between the temperature sensor and the interface.

The base adapter may therefore already have the temperature sensor for the temperature monitoring process. However, the energy supply of the temperature sensor and/or the evaluation of the temperature data may be provided by the expansion module only when required. It is thus made possible to enhance the maximum possible charging current of the adapter in a particularly efficient and reliable manner.

The base adapter may comprise at least one communication interface for coupling a communication line, in particular a CAN bus, of the base adapter to the expansion module. The expansion module may thus be incorporated into the communication of the charging process in an efficient and reliable manner, in particular for monitoring the temperature of the base adapter.

The adapter may comprise the expansion module. In this case, the expansion module may be designed to be mechanically connected to the base adapter, in particular via mutually facing housing walls of the base adapter and of the expansion module (for example via a connecting rail and/or via a latching mechanism).

The expansion module may be designed to supply electrical energy to the base adapter, in particular for the temperature monitoring process. The expansion module may have an, in particular rechargeable, energy storage device for this purpose. As an alternative or in addition, the expansion module may be designed to draw electrical energy for the operation of the expansion module and/or the base adapter from the charging station (at which the charging process is being carried out) via the charging-station-side adapter interface of the base adapter.

The energy supply to the base adapter, in particular to the temperature sensor, can thus be provided in an efficient and reliable manner by the expansion module. The base adapter may be designed to be passive (that is to say without a power supply) in “stand-alone” operation in order to make possible a charging process with a base charging current. A particularly efficient base charging process with a base charging current can thus be made possible by means of the base adapter.

The expansion module may comprise a control unit (for example a microprocessor) which is designed to monitor the temperature of the base adapter. As an alternative or in addition, the control unit may be set up to transmit data, in particular data in relation to a temperature of the base adapter (for example the temperature data of the temperature sensor) and/or data in relation to an authentication, to the vehicle and/or to the charging station via a communication line of the base adapter. As an alternative or in addition, the control unit may be set up to cause the charging process brought about by means of the base adapter to be interrupted or (in relation to the charging current) restricted, in particular when a temperature threshold value of the base adapter is reached or exceeded.

By providing a control unit in the expansion module, it is possible to provide in an efficient manner an intelligent adapter with an increased charging current.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways. Furthermore, features cited in brackets should be understood as optional features.

The invention is described in more detail below using exemplary embodiments.

### BRIEF DESCRIPTION OF THE DRAWINGS

FIG. 1 shows an exemplary vehicle which is being charged at a charging station;

FIG. 2 shows an exemplary adapter between different charging standards; and

FIGS. 3a to 3c are schematic views of an exemplary charging adapter which can be scaled in terms of power.

### DETAILED DESCRIPTION OF THE DRAWINGS

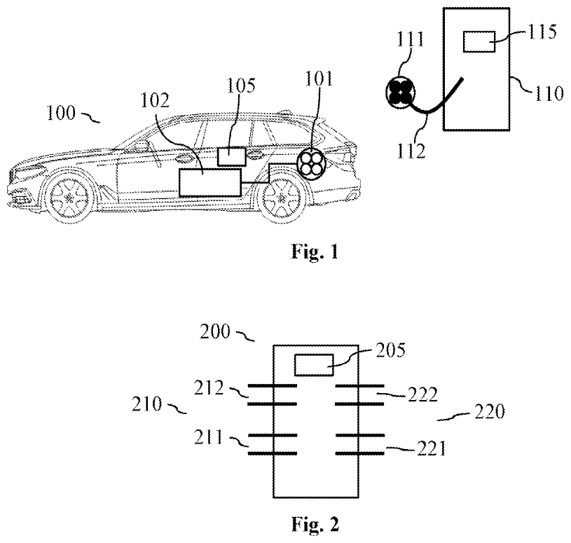

As explained at the outset, the present document deals with making possible, in an efficient and reliable manner, charging processes in which the charging station and the vehicle which is to be charged have different charging standards. In this context, FIG. 1 shows an exemplary charging system having a charging station 110 and a vehicle 100. The vehicle 100 comprises an electrical energy storage device 102 which can be charged with electrical energy from the charging station 110. The vehicle 100 comprises a charging jack 101 (generally referred to as a charging interface) to which a corresponding (charging) plug 111 (generally referred to as a charging interface) of a charging cable 112 can be plugged. The charging jack 101 and the plug 111 form a plug system. The charging cable 112 can be fixedly connected to the charging station 110 (as illustrated). The charging cable 112 may be connected on the other side to the charging unit 110 by means of a plug connection (for example in the case of AC charging). The charging station 110 and the vehicle 100 also each comprise a control unit 115, 105 which are configured to control a charging process. Data may be communicated between the two control units 115, 105 via the charging cable 112 for this purpose.

The charging station 110 and a vehicle 100 which is to be charged may be designed in accordance with different charging standards. For example, the charging station 110 may be designed in accordance with the GB/T charging standard and the vehicle 100 may be designed in accordance with the ChaoJi charging standard. The different charging standards may differ in relation to one more of the following properties:
an arrangement of the contact elements (in particular the pins) of the plug system; and/or
the communication protocol used for the data communication.

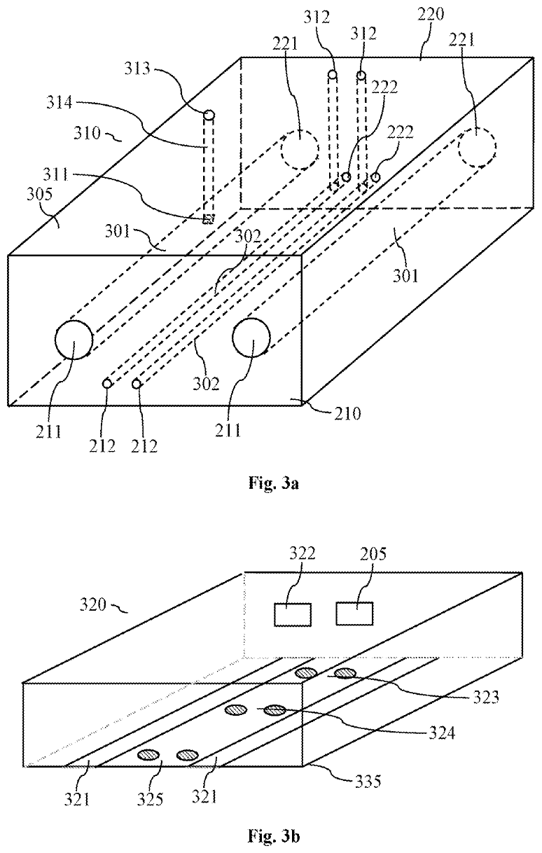

The charging socket 101 of the vehicle 100 may therefore be designed in accordance with a vehicle-side charging standard and the charging plug 111 of the charging station 110 may be designed in accordance with a (different) charging-station-side charging standard. In order to still make a charging process possible, an adapter 200 may be provided (as illustrated in FIG. 2), which has on the vehicle side a charging plug 210 (generally referred to as an adapter interface), which is designed in accordance with the vehicle-side charging standard, and on the charging-station side a charging socket 220 (generally referred to as an adapter interface), which is designed in accordance with the charging-station-side charging standard.

The charging plug 210 has power contact elements 211 (for transmitting the charging current) and/or communication contact elements 212 (for transmitting communication signals), which have an arrangement and/or shape complementary to the charging socket 101 of the vehicle 100, such that the charging plug 210 and the charging socket 101 form a plug system in accordance with the vehicle-side charging standard.

Correspondingly, the charging socket 220 has power contact elements 221 (for transmitting the charging current) and/or communication contact elements 222 (for transmitting communication signals), which have an arrangement and/or shape complementary to the charging plug 111 of the charging station 110, such that the charging plug 110 and the charging socket 220 form a plug system in accordance with the charging-station-side charging standard.

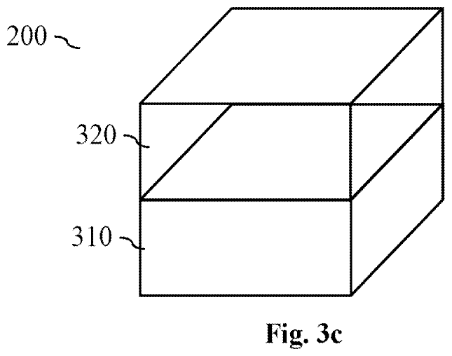

The adapter 200 may be of modular construction in order to be able to increase the charging power of the adapter 200 when needed. In particular, the adapter 200, as illustrated in FIGS. 3a to 3c, may have a base adapter 310 which can be expanded by an expansion module 320 in order to increase the maximum possible electrical charging power and/or the maximum possible charging current of the adapter 200. In particular, the base adapter 310 and the expansion module 320 may be designed to be arranged alongside one another (as illustrated by way of example in FIG. 3c) in order to provide an adapter 200 with an increased charging power (in comparison to the base adapter 310). Charging processes between different charging standards can thus be made possible in a particularly efficient and flexible manner.

The base adapter 310 comprises (as illustrated by way of example in FIG. 3a) a charging plug 210 on the vehicle side and a charging socket 220 on the charging-station side. The arrangement of the contact elements 211, 212, 221, 222 may in this case be different on the vehicle side and the charging station side (in accordance with the respective charging standard). Power lines 301 and/or communication lines 302 may run between the charging plug 210 and the charging socket 220.

The base adapter 310 may also have at least one temperature sensor 311 which is designed to capture temperature data in relation to the temperature of the base adapter 310, in particular in relation to the temperature of a power line 301 of the base adapter 310. The temperature data may the led via a data line 314 up to a data interface 313 on a housing wall 305 of the housing of the base adapter 310.

The base adapter 310 may also have one or more data interfaces 312 via which the communication signals are provided on the one or more communication lines 302 on the housing wall 305.

The base adapter 310 may be designed to be operated with a base charging power and/or with a base charging current (for example 125 A) when no temperature monitoring is performed (that is to say without the temperature data of the temperature sensor 311 being evaluated). It is therefore possible to provide an efficient (passive) base adapter 310 for a relatively low base charging power.

FIG. 3b shows an exemplary expansion module 320 which is designed to be coupled to the base adapter 310, for example to be coupled to one another via mutually adjoining housing walls 305, 335. In this case, the expansion module 320 may have (on a housing wall 335 of the housing of the expansion module 320) a data interface 323 for transferring the temperature data from the temperature sensor 311 of the base adapter 310. The data interface 323 of the expansion module 320 may be complementary to the corresponding data interface 313 of the base adapter 310.

The expansion module 320 may also have an interface 324 for the data of a voltage sensor (for example for identifying a communication signal). As an alternative or in addition, the expansion module 320 may have an interface 325 for transferring communication signals from or to a communication line 302.

The expansion module 320 may have an energy interface 321 (for example a conductive contact strip) which makes it possible to supply energy to the expansion module 320 from the base adapter 310 and/or from an energy source of the charging station 110. As an alternative or in addition, the expansion module 320 may have an internal energy storage device 322 (for example a, possibly rechargeable, battery).

The expansion module 320 comprises a control unit 205 which is designed to evaluate the temperature data of the temperature sensor 311 of the base adapter 310 in order to monitor the temperature of the base adapter 310, in particular a power line 301 of the base adapter 310. The control unit 205 may also be set up to cause a charging process to be interrupted and/or for the charging power of the charging process to be reduced when it is identified, based on the temperature data, that the temperature of the base adapter 310 has reached or exceeded a specific temperature threshold value. It is therefore possible to monitor the temperature of the base adapter 310. This makes it possible to operate the base adapter 310 with an increased charging power or with an increased charging current, these being increased with respect to the base charging power or the base charging current.

The expansion module 320 may make communication with the vehicle 100 possible, in particular for identification of an excessive temperature of the adapter 200 and/or for authentication.

The expansion module 320 may have an energy storage device 322 which may be recharged if necessary. In this case, the expansion module 320 may provide the electrical energy supply for one or more (low-voltage) components, for example for the temperature sensor 311, of the base adapter 310 and/or of the expansion module 320.

The expansion module 320, in particular the control unit 205 of the expansion module 320, may be set up to identify a fault in the adapter 200 before, during and/or after a charging process. It is possible to stop a charging process in response to an identified fault. A specific communication signal on a communication line 302 of the base adapter 310 can be provided for this purpose.

It is therefore possible to provide a base adapter 310 (without peripherals and/or without intelligence) which is designed exclusively to establish compatibility between the vehicle-side charging standard and the charging-station-side charging standard. The base adapter 310 may have a base current-carrying capability (which is halved, for example, in comparison with the increased current-carrying capability).

The base adapter 310 may be expanded by peripherals by way of an expansion module 320. One or more contact points 312, 313 may be provided in the base adapter 310 for the connection of the expansion module 320. The peripherals in the expansion module 320 may have some of the temperature measurement technology, which makes it possible to monitor the temperature, as a result of which it is made possible to increase (in particular to double) the current-carrying capability. In this case, the state of the electrical contacts of the base adapter 310 may be monitored by way of the temperature monitoring process.

The charging-station-side charging standard (for example the GB/T charging standard) may provide a voltage supply for components of a charging system from the charging station 110. This voltage supply may be used by the charging station 110 to supply electrical energy to the expansion module 320 and thus to one or more components of the base adapter 310. The base adapter 310 may be supplied with energy in this case via one or more contact points or interfaces 321, 323, 324, 325.

As already illustrated above, the expansion module 320 may have a control unit 205, in particular a CAN (controller area network) microcontroller, which is designed to communicate with the (control unit 115 of the) charging station 110 and/or with the vehicle 100 (or with the control unit 105 of the vehicle 100) via a communication line 302 of the base adapter 310. For example, a CAN bus may be provided by means of the communication line 302. The communication may be used for authentication in advance of a charging process and/or for monitoring and/or for transmission of one or more operating parameters (in particular the temperature) of the base adapter 310.

The present invention is not restricted to the exemplary embodiments shown. In particular, it should be noted that the description and the figures are intended to illustrate only by way of example the principle of the proposed methods, devices and systems.

1.-10. (canceled)

11. An adapter for a charging process of a vehicle having a vehicle-side charging interface, which is designed in accordance with a vehicle-side charging standard, at a charging station having a charging-station-side charging interface, which is designed in accordance with a charging-station-side charging standard which differs from the vehicle-side charging standard, the adapter comprising:
a base adapter having a vehicle-side adapter interface for connecting to the vehicle-side charging interface and having a charging-station-side adapter interface for connecting to the charging-station-side charging interface, wherein
the base adapter is designed to be operated with a base charging current when no temperature monitoring is performed,
the base adapter is designed to be expanded, for monitoring the temperature of the base adapter, with an expansion module, and
the base adapter is designed to be operated with an increased charging current in comparison with the base charging current when temperature monitoring is performed.

12. The adapter according to claim 11, wherein the base adapter further comprises:
a temperature sensor which is set up to capture temperature data in relation to a temperature of the base adapter, and
an interface for providing the temperature data to the expansion module and/or for taking up electrical energy from the expansion module for operation of the temperature sensor.

13. The adapter according to claim 12, wherein
the temperature sensor is configured to capture temperature data in relation to a temperature of an electrical power line of the base adapter for transmitting charging current.

14. The adapter according to claim 11, wherein
the vehicle-side adapter interface comprises one or more power contact elements and one or more communication contact elements, which are configured in accordance with the vehicle-side charging standard, and
the charging-station-side adapter interface comprises one or more power contact elements and one or more communication contact elements, which are configured in accordance with the charging-station-side charging standard.

15. The adapter according to claim 14, wherein the base adapter further comprises:
one or more power lines between the one or more power contact elements of the vehicle-side adapter interface and the one or more power contact elements of the charging-station-side adapter interface, and/or
one or more communication lines between the one or more communication contact elements of the vehicle-side adapter interface and the one or more communication contact elements of the charging-station-side adapter interface.

16. The adapter according to claim 11, wherein the base adapter further comprises:
at least one communication interface for coupling a communication line of the base adapter to the expansion module.

17. The adapter according to claim 16, wherein the communication line is a CAN bus.

18. The adapter according to claim 11, wherein
the base adapter is designed such that, through the temperature monitoring, the increased charging current is at least doubled in comparison with the base charging current.

19. The adapter according to claim 11, wherein
the adapter comprises the expansion module which is designed to be mechanically connected to the base adapter via mutually facing housing walls of the base adapter and of the expansion module.

20. The adapter according to claim 19, wherein
the expansion module is designed to supply electrical energy to the base adapter for the temperature monitoring process, and
the expansion module comprises an energy storage device, and/or
the expansion module is designed to draw electrical energy for operation of the expansion module and/or of the base adapter from the charging station via the charging-station-side adapter interface of the base adapter.

21. The adapter according to claim 20, wherein
the energy storage device is a rechargeable energy storage device.

22. The adapter according to claim 19, wherein the expansion module comprises:
a control unit which is configured to:
monitor a temperature of the base adapter; and/or
transmit data in relation to the temperature of the base adapter and/or in relation to an authentication, to the vehicle and/or to the charging station via a communication line of the base adapter; and/or
cause the charging process brought about by use of the base adapter to be interrupted or restricted when a temperature threshold value of the base adapter is reached or exceeded.

23. The adapter according to claim 11, wherein
the charging-station-side charging standard is the GB/T charging standard, and
the vehicle-side charging standard is the ChaoJi charging standard.
